(19) United States
(12) Patent Application Publication
(10) Pub. No.: US 2025/0305633 A1
(43) Pub. Date: Oct. 2, 2025

(54) Pressure cylinder made of a thin-walled welded stainless steel vessel and its production method

(71) Applicant: A&S Composite s.r.o., 155 21 Praha 5 (CZ)

(72) Inventor: Vladislav LUKYANETS, Praha (CZ)

(73) Assignee: A&S Composite s.r.o., 155 21 Praha 5 (CZ)

(21) Appl. No.: 19/066,243

(22) Filed: Feb. 28, 2025

(30) Foreign Application Priority Data
Feb. 29, 2024 (CZ) PV 2024-77

(51) Int. Cl. F17C 1/14; B23K 9/028

(52) U.S. Cl. CPC F17C 1/14; B23K 9/028; F17C 2201/0109; F17C 2203/0617; F17C 2203/0643; F17C 2209/221; F17C 2221/011; F17C 2270/0189

(57) ABSTRACT

A pressure cylinder made of thin-walled welded stainless steel vessel fitted with a composite shell and a neck with an external and/or internal thread, where the neck is attached to the thin-walled vessel by a circular welded seam with a hermetic seal and containing a flange which is fitted circumferentially with a pair of tapered grooves on its outer surface whose adjacent sides meet on an annular ridge on which there are locking teeth in the direction of the longitudinal axis of the neck and composite fibers are placed in inter-tooth spaces. The method of producing a pressure cylinder includes the welding of a neck to the thin-walled vessel with a hermetic seal, whereupon composite fibers with stress less than the total force acting on the fiber bundle are wound into additional grooves between the teeth and further winding of the fiber around the neck is carried out while simultaneously moving bilaterally along the axis of the shell to position the fiber between the teeth, whereupon fibers with a nominal stress value are wound and final winding of the reinforced composite shell is carried out.

### BACKGROUND AND SUMMARY

The invention relates to a pressure cylinder made of a thin-walled welded stainless steel vessel fitted with a composite shell and a neck with external and/or internal thread and its production method.

Various design solutions of pressure cylinders are known from technical practice. There are all-metal cylinders that are quite heavy; their mechanical properties are highly dependent on the chosen materials. Their maintenance is quite demanding as they can start to corrode and the like.

Furthermore, plastic pressure cylinders are known but have low strength and are only suitable for low-pressure fillings.

There are also pressure cylinders made of a thin-walled welded stainless steel vessel with a reinforced composite shell. The neck of the vessel consists of a separate element with a threaded hole or external threaded fitting. The neck is welded to the thin-walled vessel. During the production and operation of the cylinders, the neck is subjected to significant torque, which can lead to the destruction of the weld holding the neck.

One technical solution is known from patent EP 2532930, in which the flange is fixed in the ring using grooves of a non-circular shape. This solution is not optimal in terms of torque transfer because the composite fibers on the neck do not take the load longitudinally but only in combination with the polymer matrix, which significantly reduces the mechanical properties of the material. The circular groove also does not transfer axial loads, in contrast to the two tapered surfaces designed, which reliably prevent axial displacement of the neck and thus protect the weld from damage.

According to an aspect of the present invention, the aforementioned deficiencies are mostly eliminated by a pressure cylinder made of a thin-walled welded stainless steel vessel fitted with a composite shell and a neck with an external and/or internal thread. Its essence is that the neck is attached to the thin-walled vessel by a circular welded seam with a hermetic seal. The neck contains a flange which is fitted circumferentially with a pair of tapered grooves on its outer surface whose adjacent sides meet on an annular ridge on which there are locking teeth in the direction of the longitudinal axis of the neck and composite fibers are placed in the inter-tooth spaces.

In an advantageous embodiment in the transverse direction, the inter-tooth spaces have a shape selected from the group of trapezoidal groove, U-shaped groove, and tapered hole.

The two designed tapered surfaces reliably prevent the axial displacement of the neck and thus protect the weld from damage.

A further aspect of the invention is the method of manufacturing the above-described pressure cylinder. Its essence is that a neck is welded to the thin-walled vessel with a hermetic seal, which contains a flange which is fitted circumferentially with a pair of tapered grooves on its outer surface meeting on an annular ridge on which there are locking teeth, whereupon composite fibers with stress less than the total force acting on the fiber bundle are wound into the grooves between the teeth and further around the shell. Next, further winding of the fiber around the neck is carried out while simultaneously moving bilaterally along the axis of the shell to position the fiber between the teeth, whereupon the fiber with the nominal stress value is wound, and the final winding of the reinforced composite shell is carried out.

The number of winding cycles with stress less than the total force acting on the fiber bundle preferably corresponds to the number of grooves between the teeth. modular construction system

A circular welded seam ensures a hermetic seal. The design and technological solution lie in the shape of the neck and also in the production method of these cylinders. To prevent damage and destruction of the weld, the flange is designed with locking teeth on the outer surface of the flange. The flange has two tapered grooves forming an annular ridge. In the next technological operation, trapezoidal grooves are made, or tapered holes are drilled in the transverse direction on the ridge to create the alternation of teeth and grooves.

The following cylinder production process consists of or comprises two phases.

In the first phase, the winding of the fibers is started with a low stress that does not exceed the total force acting on the fiber bundle to avoid damage to the weld seam of the neck. In this phase, further winding of the fiber around the neck is carried out while simultaneously moving bilaterally along the axis of the vessel so that the fiber lies between the teeth. The number of cycles should be equal to the number of grooves on the flange to ensure uniform fastening of the fiber.

In the second phase, the fiber stress is increased to the nominal value, and the final winding of the reinforced composite shell is performed. At the same time, additional threads of fiber can be made around the neck for a more reliable fixation of the neck during cylinder operation.

After the polymerization procedure, the reinforced shell and its part around the neck accept external loads more optimally due to the fact that, unlike known solutions, the fibers are intertwined around the teeth and work in tension.

### BRIEF DESCRIPTION OF THE DRAWINGS

According to the present invention, the pressure cylinder will be described in more detail using specific exemplary embodiments using the accompanying drawings, where

FIG. 1 shows an exemplary cylinder in a side view.

FIGS. 2a and 3a show details of the neck and FIGS. 2b and 3b show this neck in the corresponding section.

FIGS. 4a and 4b show various grooves on the neck flange in an axonometric view.

FIG. 5 shows a view of the cylinder in the direction of the neck, and

FIG. 6 shows details of the fibers and neck.

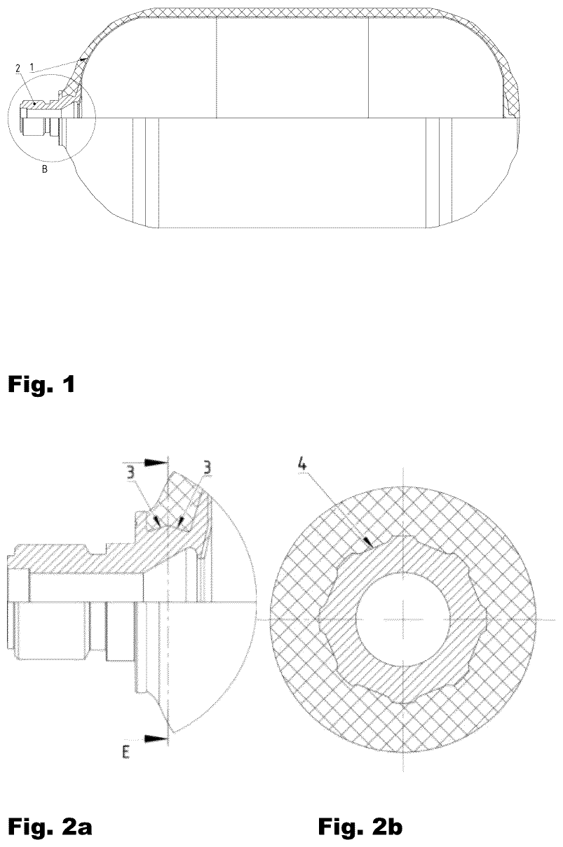

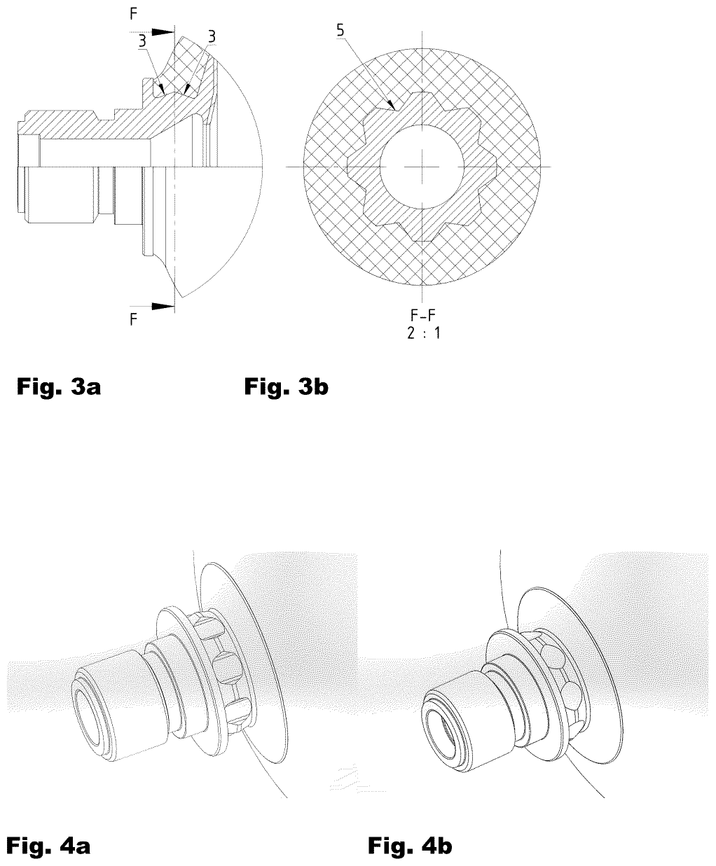

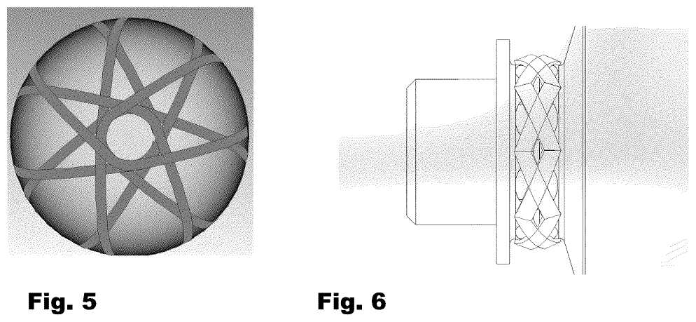

### DETAILED DESCRIPTION

An exemplary pressure cylinder made of thin-walled welded stainless steel vessel 1 with a reinforced composite shell and neck 2 with an external thread, neck 2 is attached to the thin-walled vessel 1 by a circular welded seam with a hermetic seal. Neck 2 contains a flange which is fitted circumferentially with a pair of tapered grooves 3 on its outer surface whose adjacent sides meet on an annular ridge on which there are locking teeth in the direction of the longitudinal axis of the neck 2, and composite fibers are placed in the inter-tooth spaces 4, 5. The inter-tooth spaces 4, 5 have the shape of a trapezoidal groove in the transverse direction in one embodiment and a tapered groove in the other.

During the production of the pressure cylinder, neck 2 is welded to the thin-walled vessel 1 with a hermetic seal, which contains a flange which is fitted circumferentially with a pair of tapered grooves 3 on its outer surface meeting on an annular ridge on which there are locking teeth, whereupon composite fibers with stress less than the total force acting on the fiber bundle are wound into further grooves 4 and 5 between the teeth and then around the shell, and further winding of the fiber around the neck 2 is carried out while simultaneously moving bilaterally along the axis of the shell to position the fiber between the teeth, whereupon the fibers with a nominal stress value are wound and final winding of the reinforced composite shell is carried out. The number of winding cycles with stress less than the total force acting on the fiber bundle corresponds to the number of grooves between the teeth.

The combination of a thin-walled stainless steel liner and a reinforced composite shell made of high-strength carbon enables the production of a lightweight cylinder, which is very important when used as a storage tank for oxygen and other gases in the aerospace industry.

In addition, this technical solution will increase the structure's operational safety and reduce the weight of the reinforced shell in the neck area due to a more rational use of the properties of the composite material.

According to this technical solution, the pressure cylinder finds its application mainly in the aerospace industry, divers, firefighters, and the like.

1. A pressure cylinder made of thin-walled welded stainless steel vessel (1) with a composite shell and a neck (2) with an external and/or internal thread, characterized in that the neck (2) is attached to the thin-walled vessel (1) by a circular welded seam with a hermetic seal and containing a flange which is fitted circumferentially with a pair of tapered grooves (3) on its outer surface whose adjacent sides meet on an annular ridge on which there are locking teeth in the direction of the longitudinal axis of the neck (2) and composite fibers are placed in inter-tooth spaces (4, 5).

2. The pressure cylinder according to claim 1, characterised in that the inter-tooth spaces (4, 5) have a shape selected from the group trapezoidal groove, U-shaped groove, and tapered hole in the transverse direction.

3. A method of producing a pressure cylinder according to claim 1, characterised in that a neck is welded to the thin-walled vessel with a hermetic seal, which contains a flange which is fitted circumferentially with a pair of tapered grooves on its outer surface meeting on an annular ridge on which there are locking teeth, whereupon composite fibers with stress less than the total force acting on the fiber bundle are wound into additional grooves between the teeth and then around the shell, and further winding of the fiber around the neck is carried out while simultaneously moving bilaterally along the axis of the shell to position the fiber between the teeth, whereupon fibers with a nominal stress value are wound, and final winding of the reinforced composite shell is carried out.

4. The method of producing a pressure cylinder according to claim 3, characterised in that the number of winding cycles with stress less than the total force acting on the fiber bundle corresponds to the number of additional grooves between the teeth.
